(19) United States
(12) Patent Application Publication
(10) Pub. No.: US 2005/0200485 A1
(43) Pub. Date: Sep. 15, 2005

(54) Article containing anti-theft device

(75) Inventors: Sean M. Connolly, Clemson, SC (US); Philip F. Minalga, Pendleton, SC (US); Stephen S. Quick, Pickens, SC (US)

Correspondence Address: BRINKS HOFER GILSON & LIONE, P.O. BOX 10395, CHICAGO, IL, 60610, US

(73) Assignee: One World Technologies Limited

(21) Appl. No.: 11/055,335

(22) Filed: Feb. 9, 2005

Related U.S. Application Data
(60) Provisional application No. 60/542,894, filed on Feb. 9, 2004.
(60) Provisional application No. 60/564,047, filed on Apr. 20, 2004.
(60) Provisional application No. 60/583,725, filed on Jun. 28, 2004.

(51) Int. Cl. G08B 13/14

(52) U.S. Cl. 340/572.8

(57) ABSTRACT

An article, such as a power tool, that includes a housing, a motor, and an anti-theft device is provide. The anti-theft device may be disposed within the housing or within a cavity located in the housing and may be enclosed by a covering, such as an adhesive label. Alternatively, the anti-theft device may be affixed to or contained within a cord strap. For example, the anti-theft device may be housed within a clip that attaches the cord strap to the power cord of the article. The anti-theft device may be located on a component of the article remote from the motor to decrease the likelihood that the anti-theft device will be deactivated by a magnetic or electromagnetic field generated by the motor. In addition, a method is provided for deterring the theft of electronic articles. The method includes placing an anti-theft device inside an article that contains a motor and activating the anti-theft device by passing the article through a magnetic field with the device having an appropriate polarity.

### RELATED APPLICATIONS

This application claims the benefit of the filing date under 35 U.S.C. §119(e) of Provisional U.S. Patent Application Ser. Nos. 60/542,894 (filed Feb. 9, 2004), 60/564,047 (filed Apr. 20, 2004), and 60/583,725 (filed Jun. 28, 2004), each of which are hereby incorporated herein by reference.

### BACKGROUND OF THE INVENTION

The present invention relates to articles containing anti-theft devices and methods for deterring the theft of articles.

Anti-theft devices such as security tags or electronic article surveillance systems are used for inventory control and for preventing unauthorized removal of articles from a controlled area. Typically, such systems include a transmitter and a receiver that are used to establish a surveillance zone, which must be traversed by any articles being removed from the controlled area. The transmitting and receiving antennas are typically mounted in floors, walls, and ceilings or may be in the form of freestanding pylons.

Such anti-theft devices may be combined with Radio Frequency Identification (RFID) technology to provide enhanced inventory control or other functionality. An RFID transponder is typically operated in conjunction with an RFID base station, which generates a continuous wave electromagnetic disturbance that is modulated to correspond to data that is to be communicated by the disturbance. The modulated disturbance, or signal, communicates this information and the RFID base station transmits an interrogating signal which is modulated by a receiving tag to impart information stored within the tag to the signal. The receiving tag then transmits the modulated, answering, RF signal to the base station. This RFID technology is described in U.S. Pat. Nos. 5,939,984; 6,121,878; and 6,147,606, each of which are incorporated herein by reference.

The anti-theft device, such as a security tag, may be affixed to or positioned within an article and may include a sensor adapted to interact with a signal being transmitted by the system transmitter into the surveillance zone. If the security tag on an article has not been deactivated and the tagged article is transported through the surveillance zone, the security tag acts as a transponder and generates a return signal that can be identified by the receiver. The receiver can then initiate an audible alarm, for example, or trigger other protective measures.

Certain types of security tags are designed to be disposable and are generally not removable to the point of sale. Therefore, the security tag must be deactivated before the article containing the security tag is removed from the security area. Deactivation may be accomplished by equipment that changes an electromagnetic or magnetic characteristic of the security tag so that the security tag is no longer detectable at the surveillance zone. These types of security tags may, however, cover important information printed on the article's packaging and present an appearance that is not aesthetically pleasing. Furthermore, such tags may be subject to tampering by consumers or other individuals not authorized to remove the devices.

One solution to that problem has been to provide security tags that are designed to be reusable and, thus, include releasable attachment devices for affixing the tags to the articles. Such attachment devices are further designed to be releasable only by authorized personnel with the use of a special tool or detaching mechanism. Examples of security tags are disclosed in U.S. Pat. Nos. 4,221,025; 4,299,870; and 5,426,419.

The effectiveness of security tags and other anti-theft devices, however, can be detrimentally affected by magnetic fields present in the surrounding environment, such as magnetic fields created by the motor of an electronic article. These magnetic fields may decrease the ability of the security tag to be detected by the detection equipment or may completely deactivate the device, thereby eliminating the device's ability to activate the detection equipment at all.

Prior attempts to alleviate this problem include housing a security tag in a one or two piece cylinder that is snapped together to form a permanent mechanical seal around a power cord, rather than attaching the security tag directly to the body of the article containing a motor. This attempted solution, however, results in a conspicuous security tag that is cumbersome in the use of the article. Further, positioning the security tag in this manner increases manufacturing costs without contributing to the functionality or aesthetics of the product.

Therefore, there is a need for an apparatus that deters the theft of electronic articles by inconspicuously incorporating an anti-theft device into a functional part of the article without compromising the use of the power tool. There is also a need for a method that deters the theft of electronic articles and prevents a decrease in the effectiveness of or deactivation of the anti-theft devices associated with these articles, caused by exposure to a magnetic or electromagnetic field generated by the motor in the article.

### SUMMARY

One aspect of the present invention is directed to an electronic article, such as a power tool, containing a housing, a motor, and an anti-theft device. The anti-theft device may be placed within the housing or within a cavity located in the housing. If the anti-theft device is placed within a cavity in the housing, a covering, such as an adhesive label, may be placed over the cavity to disguise the anti-theft device. Desirably, the anti-theft device is positioned on or in a component remote from the motor of the article. The anti-theft device may also be affixed to or placed within a cord strap or other functional component associated with the article. A cord strap containing an anti-theft device not only deters theft, but also contributes to the functionality of the product by restraining the cord during transport and storage.

Affixing an anti-theft device to or incorporating it into a portion of an electronic article, such as the handle, cord strap, or other component of a power tool, may have several advantages, such as: (a) decreasing the potential for tampering with the anti-theft device, (b) increasing the aesthetics of the external packaging, (c) minimizing the risk that the anti-theft device will be deactivated by exposure to a magnetic field created by the motor in the article, and (d) providing a simple and inexpensive technique for bringing any electronic article into compliance with the certification programs required by many retail facilities (e.g., the requirement that the anti-theft device be located within three inches of the UPC bar code). The article of the present invention not only deters theft, but may also increase the efficiency of the retail facility by allowing the anti-theft device to be placed in close proximity to the UPC bar code, thereby allowing nearly simultaneous deactivation of the anti-theft device and scanning of the bar code at the point of sale.

Another aspect of the present invention is directed to a method for deterring the theft of an article, particularly an article containing a motor such as a power tool. The method may include placing an anti-theft device inside an article and reactivating the device after it has undergone a decrease in effectiveness because of exposure to a magnetic or electromagnetic field. To reactivate the device, the product may be passed through a magnetic field with the anti-theft device in an appropriate polarity. The product containing the reactivated anti-theft device may then be packaged for distribution without the concern that the anti-theft device will not activate or set off the device detection equipment when necessary. When the product is being purchased, the anti-theft device may be deactivated to prevent activation of the detection equipment as the customer leaves the store.

The method of the present invention may include inserting an anti-theft device into a cavity located in the housing of an electronic article and placing a covering over the cavity to disguise the anti-theft device. Desirably, the cavity is placed on a component remote from the motor in the article, thereby reducing the risk that the anti-theft device will be deactivated by the running of the motor. The cavity may be covered with an adhesive label, such as a label containing safety information, brand information, or bar code information.

Alternatively, the method may include attaching an anti-theft device to, or incorporating it into, a cord strap associated with the article and placing the cord strap around the cord of the article. For example, the anti-theft device may be attached to the cord strap by placing it within a clip, inserting the other end of the strap through a slot in the clip to form a loop, inserting the cord through the loop, and pulling the end of the strap to tighten the strap around the cord. The article may then be placed in a package with the anti-theft device positioned to maximize the distance between the anti-theft device and the motor inside the article, thereby reducing the risk that the anti-theft device will be deactivated by the running of the motor.

Yet another aspect of the present invention is directed to a method for preventing the deactivation of an anti-theft device by a magnetic or electromagnetic field generated by an article containing a motor. The method may include placing an anti-theft device inside a cavity of an electronic article and covering the cavity with, for example, an adhesive label. Desirably, the cavity is located on a component remote from the motor. Alternatively, the method may include placing an anti-theft device on a cord strap, securing the cord strap around the article, and placing the article within a package with the anti-theft device positioned to maximize the distance between the anti-theft device and the motor inside the article.

### BRIEF DESCRIPTION OF THE DRAWINGS

FIG. 1 shows one embodiment of the present invention in the form of a power tool having a motor and at least one handle. An anti-theft device is securely located within the handle.

FIG. 2 shows one embodiment of the present invention in which an anti-theft device is housed behind a label and within a cavity in a plastic component of a power tool.

FIG. 3 shows the embodiment depicted in FIG. 2 with the label partially removed to reveal the anti-theft device in the cavity.

FIG. 4 shows another embodiment of the present invention in which an anti-theft device is housed in a cavity in a power tool handle and covered with a label.

FIG. 5 shows yet another embodiment of the present invention in which an anti-theft device is housed in a cavity in a chain brake for a chainsaw, remote from the motor but in close proximity to a bar code label placed on the packaging.

FIG. 6 shows one embodiment of the present invention in which an anti-theft device is housed within a clip attached to a cord strap.

FIG. 7 shows the cord strap depicted in FIG. 6 after the loose end of the strap is pulled to tighten the other end of the strap around a cord.

FIG. 8 shows the cord strap depicted in FIG. 7 after the loose end of the strap is wrapped around the coiled cord of a power tool.

FIG. 9 shows the cord strap and power tool depicted in FIG. 8 after being positioned inside a case.

FIG. 10 is a schematic of one embodiment of the process of the present invention. The process shows a method of reactivating an anti-theft device exposed to a magnetic or electromagnetic field during the manufacture and subsequent testing of an article containing the anti-theft device.

### DESCRIPTION

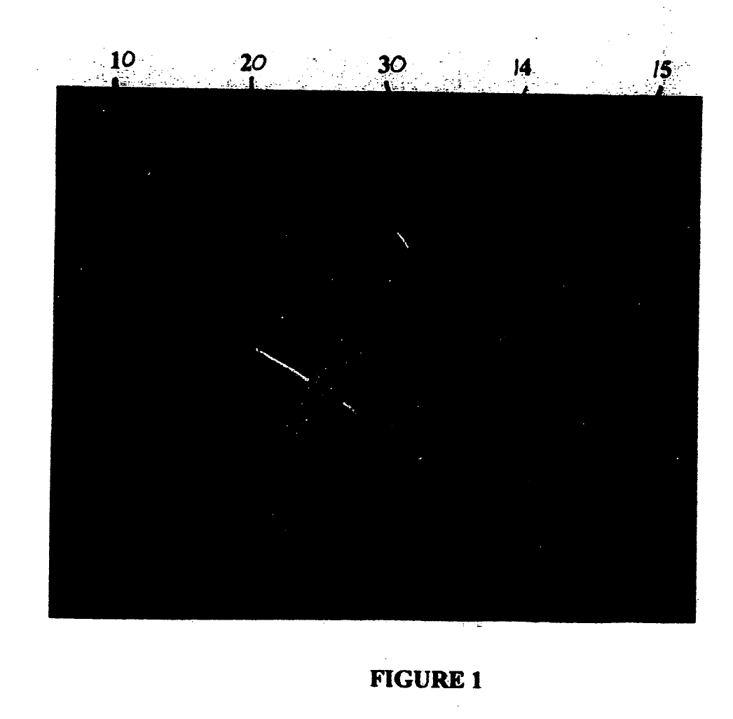

The present invention provides a power tool 10 with a housing 30, a motor 14 disposed within the housing 30, and an anti-theft device 20, disposed within a portion of the housing 30, as shown in FIG. 1. The power tool 10 is shown as a router but it may be any power tool having a housing 30 and a motor 14. During assembly of the power tool 10, the anti-theft device 20 is located within the housing 30 in a suitable location. For example, as shown in FIG. 1, the power tool 10 has a handle 15 in which the anti-theft device 20 may be located. The anti-theft device 20 may be secured to the inner portion of the housing 30 in any suitable and known manner. For example, the anti-theft device 20 may have one surface containing an adhesive that allows the anti-theft device 20 to be securely attached to any portion of the housing 30, such as a handle 15. Desirably, the portion of the housing to which the anti-theft device is attached is located remotely from the motor to minimize the possibility that the anti-theft device will be deactivated by the running of the motor during quality assurance testing, for example.

One type of anti-theft device 20 is in the form of a security tag that contains a magnetic sensor assembly that includes a magneto-mechanical active element that mechanically vibrates to generate a detectable signal at the frequency of an applied interrogation signal. Another type of security tag contains a magnetic sensor assembly that includes a soft magnetic active element that generates a detectable signal at a harmonic of the frequency of the applied interrogation signal. In both types of tags, the magnetic sensor element also includes a hard or semi-hard magnetic biasing element. By changing the magnetic state of this biasing element, the active element of the tag is enabled or disabled from generating the detectable signal, thereby activating or deactivating the tag.

In a magneto-mechanical tag, the biasing element is magnetized along its longer length dimension by a permanent magnet to activate the tag. By either degaussing the biasing element along its length or by magnetizing it along its shorter width dimension, the tag is deactivated. In a harmonic tag, when the biasing element is demagnetized, the tag is activated. By magnetizing the biasing element along its longer length dimension, the tag is then deactivated. Degaussing the biasing element along its length then activates the tag again. Suitable anti-theft devices in the form of a security tag are available from SENSORMATIC ELECTRONICS CORPORATION, Boca Raton, Fla.

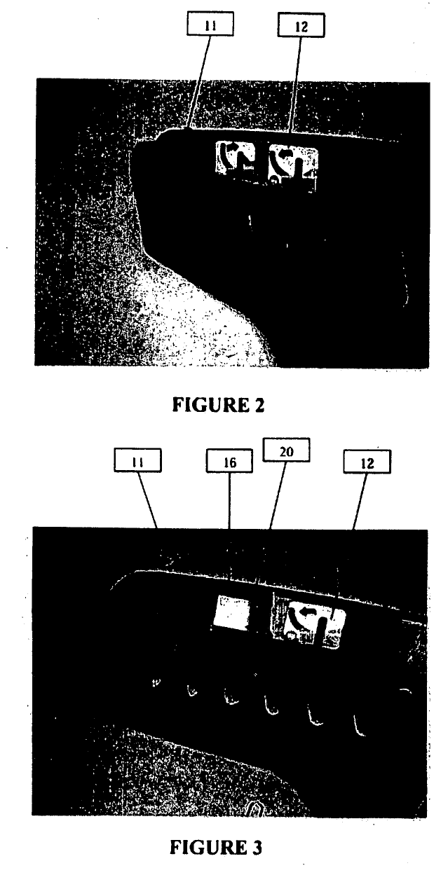

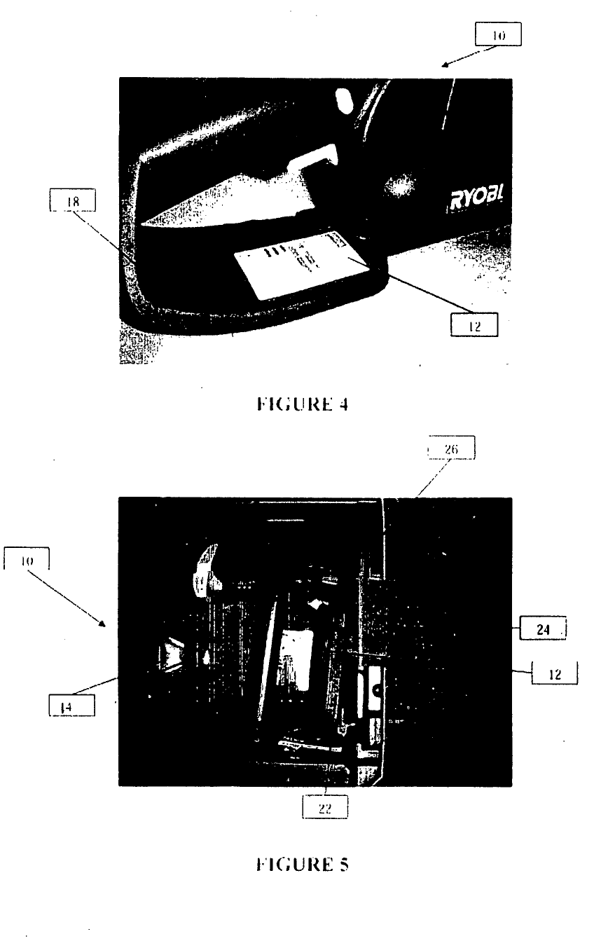

One embodiment of the present invention, as shown in FIGS. 2 and 3, includes an anti-theft device 20 disposed within a cavity 16 in a portion 11, desirably a plastic component, of a power tool. In one embodiment, the anti-theft device 20 is disposed entirely within the cavity 16. The cavity 16 may be covered with a label 12. Desirably, the component 11 in which the anti-theft device 20 is housed is located remote from the motor 14 of the power tool 10, as shown in FIGS. 4 and 5. The anti-theft device 20 may be placed loosely within the cavity 16 or may be secured within the cavity 16 in any suitable and known manner. For example, the anti-theft device 20 may have one surface containing an adhesive that allows the anti-theft device 20 to be securely attached to an inner surface of the cavity 16. Alternatively, the anti-theft device 20 may be secured to or within any component of the article or secured to or within the packaging of the article.

In the embodiment shown in FIGS. 2 and 3, the anti-theft device 20 is located in a cavity 16 behind a label 12 on a plastic component 11 of a power tool 10. More particularly, in the embodiments shown in FIGS. 4 and 5, the anti-theft device is located in a cavity behind a label 12 on the handle 18 of a power tool 10 and on a chain brake 22 for a chainsaw, respectively. Locating the anti-theft device 20 in this manner maximizes the distance between the anti-theft device 20 and the motor 14 of the power tool 10, thereby decreasing the likelihood that the anti-theft device 20 will be deactivated by a magnetic or electromagnetic field generated by the motor 14 of the power tool 10.

Although in the embodiments illustrated in FIGS. 2 through 5 the cavity 16 is covered with an adhesive label, any suitable and known material may be used as a covering. For example, the covering may be made from a hook-and-loop fastener material (as disclosed in U.S. Pat. No. 5,802,676 and sold under the trademark VELCRO) that may be secured around the edges of the cavity. Such material may also be used to secure the anti-theft device within the cavity so that, if desired, the user of the article may remove the anti-theft device after purchase and use the cavity to store small components, for example. For this purpose, it may be desirable for the covering to be secured to the cavity in a readily releasable manner, such as by use of a rigid material configured to pivot or rotate away from the cavity or to slide back and forth over the cavity, or a flexible material secured to the cavity with snaps, buttons, buckles, ties, clasps, hooks, or the like.

As shown in FIG. 5, the power tool 10 containing the anti-theft device 20 and label 12 may be placed in a package 26 for distribution to retailers, distributors, and/or consumers. The power tool 10 is shown as a chainsaw, but it may be any power tool or other electronic article. In the embodiment shown in FIG. 5, a bar code label 24 is attached to the package 26 in close proximity to the anti-theft device in the cavity covered by the label 12. This arrangement increases the efficiency of the retail facility by allowing nearly simultaneous deactivation of the anti-theft device and scanning of the bar code at the point of sale.

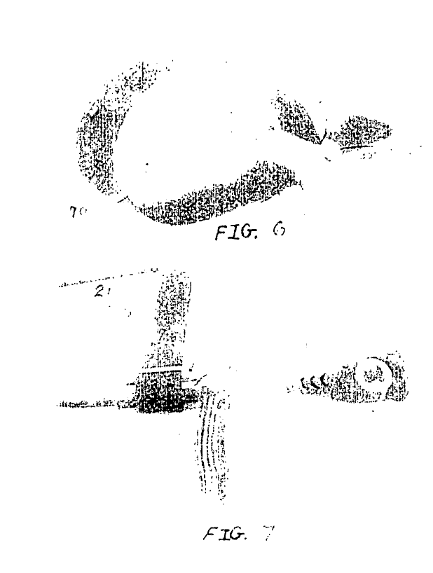

One embodiment of the present invention includes a cord strap 21 with an anti-theft device 20 disposed within a clip 30, as shown in FIGS. 6 and 7. Desirably, the clip 30 is made of plastic, but any suitable material may be used. The anti-theft device 20 may be contained within the clip 30 or may be attached to the clip 30 in any suitable and known manner. For example, the anti-theft device 20 may have one surface containing an adhesive that allows the anti-theft device 20 to be securely attached to the desired portion of the clip 30. In the embodiment depicted in FIGS. 6 and 7, the anti-theft device 20 is secured within a cavity 25 in the clip 30, which is adapted to receive the anti-theft device 20.

Alternatively, the anti-theft device 20 may be contained within or attached to any portion of the cord strap 21. For example, the anti-theft device 20 may be concealed within the cord strap 21 by placing it between two strips of material and then securing the strips around the anti-theft device 20 with an adhesive or other fastening means. The anti-theft device 20 may also be fastened directly to the cord strap 21 or placed within a housing and then fastened to the cord strap 21 in any suitable manner.

In the embodiment shown in FIG. 6, the clip 30 contains a slot 40 through which a first end 90 of strap 21 is inserted and a bottom portion 60 to which a second end 95 of the strap 21 is secured. The first end 90 is attached to an end piece 85, which serves to prevent the first end 90 of the strap 21 from sliding back through slot 40. Securing the second end 95 of the strap 21 to the bottom portion 60 of the clip 30 and inserting the first end 90 of the strap 21 through the slot 40 in the clip 30 creates a loop 70 through which an electrical cord 80 may be inserted, as shown in FIG. 7.

The clip 30 of FIGS. 6 and 7 has a first surface 45 and a second surface 55. The second surface 55 is provided with a cavity 25 to receive an anti-theft device 20. The second surface 55 is also provided with spaced apart curved portions 35 adapted to receive a cord 80 of a power device 10 such that the anti-theft device 20 is located between the cord 80 and the second surface 55 of the clip 30. The spaced apart curved portions 35 of the clip 30 terminate in a bottom portion 60 to which the strap 21 is secured.

FIG. 7 shows the cord strap 21 of FIG. 6 after the first end 90 of the strap 21 is pulled to tighten the loop 70 around the cord 80. The result of this tightening is an anti-theft device 20 securely positioned between the clip 30 and the electrical cord 80 and held in place by the strap 21. This arrangement also has the benefit of concealing the anti-theft device 20 within a functional part.

Although in this embodiment the strap 21 is attached to the cord 80 with a clip 30, any suitable and known means of attachment may be used. For example, the strap may be attached to the cord by placing the cord between a top flap of the strap and a bottom flap of the strap and securing the flaps together with rivets (as disclosed in U.S. Pat. No. 5,031,282), by encircling the cord with a hook-and-loop fastener material that may be bent back over itself and secured (as disclosed in U.S. Pat. No. 5,802,676 and sold under the trademark VELCRO), by inserting the cord into a slot or opening in the strap (as disclosed in U.S. Pat. No. 5,802,676), or by encircling the cord with a flexible strip of material and securing the material around the cord with snaps, buttons, buckles, stitches, ties, adhesive, screws, bolts, staples, clasps, hooks, or the like. In addition, the strap 21 may be formed as an integral part of the cord 80, thereby increasing the tamper-resistance of the cord strap 21 by eliminating the potential for unauthorized removal of the strap 21 and anti-theft device 20 from the cord 80.

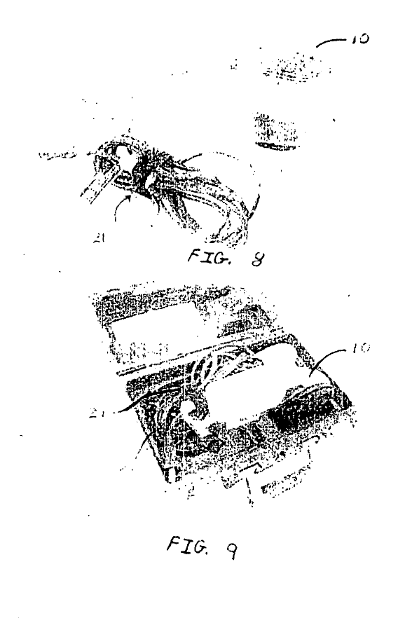

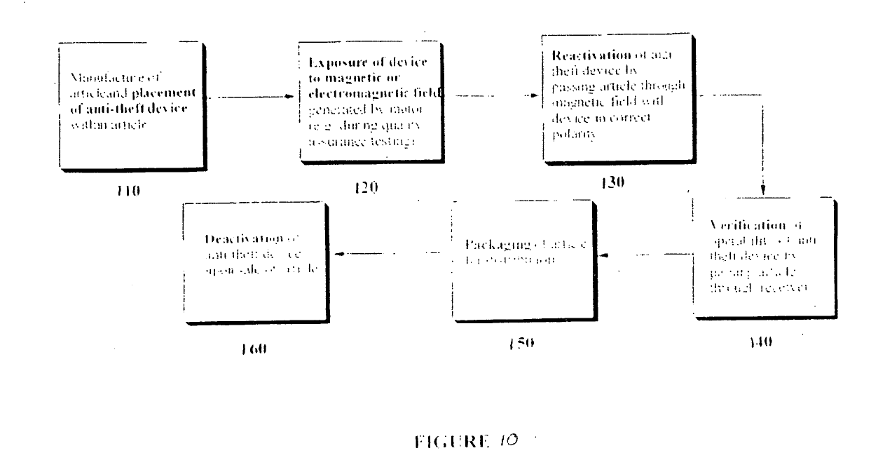

Referring now to FIG. 8, the embodiment of the cord strap 21 depicted in FIG. 7 is shown after the first end 90 of the strap 21 is wrapped around the coiled cord 80 of a power tool 10. The power tool 10 is shown as a sander, but it may be any power tool or other article with a cord. The power tool 10 and the cord 80 restrained by the cord strap 21 may then be packaged within a case 75, as shown in FIG. 9, for distribution to retailers, distributors, and/or consumers.

In another aspect of the present invention, a method for deterring the theft of an electronic article, such as a power tool, is provided. The method may include inserting an anti-theft device into a cavity located in the electronic article and covering the cavity. The covering may be made of any suitable and known material and may be secured over the cavity in any suitable and known manner. For example, the covering may be a label adhesively secured over the cavity or a flexible material secured over the cavity with snaps, buttons, buckles, stitches, ties, adhesive, screws, bolts, staples, clasps, hooks, or the like.

In one embodiment, the method includes locating the cavity on a component of the electronic article remote from the motor in the article. This configuration decreases the probability of deactivation of the anti-theft device by the running of the motor during quality assurance testing, for example.

In another embodiment, the method is performed in reverse order to detach the covering from the article and remove the anti-theft device from the cavity. The cavity may then be used as a storage compartment. Desirably, the covering is fastened over the cavity in such a way that the user may easily detach and re-attach the covering to access the items stored within the cavity.

In another embodiment, the method of the present invention includes attaching an anti-theft device to a cord strap or placing an anti-theft device within a cord strap and placing the cord strap around the cord of the article. The cord strap may then be secured around the cord in any suitable and known manner. For example, the cord strap may be secured around the cord by a first piece of fabric having protruding hooks, the first piece of fabric mating with a second piece of fabric having loops adapted to receive the hooks (as disclosed in U.S. Pat. No. 5,802,676), by inserting a button or other protrusion located on one side of the strap through an opening located on another portion of the strap (as disclosed in U.S. Pat. No. 6,523,229), or by using snaps, buttons, buckles, stitches, ties, adhesive, screws, bolts, staples, clasps, hooks, or the like.

In one embodiment, the method includes attaching the anti-theft device to the cord strap by placing it within a clip, attaching one end of the strap to the clip, inserting the other end of the strap through a slot in the clip to form a loop, inserting the cord through the loop, and pulling the end of the strap to tighten the strap around the cord. This method may be performed in reverse order to detach the strap from the cord of one article so that it may then be attached to the cord of a different article.

In yet another embodiment, the method includes packaging the electronic article for distribution to consumers, distributors, and/or retailers. A bar code label may then be placed on the package. The method of the present invention allows the bar code label to be placed within about three inches of the anti-theft device, as required by many retailers, to facilitate simultaneous deactivation of the anti-theft device and scanning of the bar code label. The anti-theft device may be positioned in a manner that maximizes the distance between the anti-theft device and the motor inside the article, thereby reducing the exposure of the anti-theft device to magnetic or electromagnetic fields that may be generated by the motor during quality assurance testing, for example.

After assembly of an electronic article such as a power tool is complete, the article is often subjected to quality assurance tests. During these tests, the article may be placed into operation, thereby generating a magnetic or electromagnetic field. These fields may decrease the effectiveness of the anti-theft device within the article or may entirely deactivate the anti-theft device. Once the anti-theft device becomes deactivated, it will no longer be sensed by the detection equipment and, therefore, will no longer serve its function of preventing theft of the article.

Accordingly, the present invention contemplates a method for preventing such deactivation, including packaging the electronic article with the anti-theft device positioned to maximize the distance between the anti-theft device and the motor inside the article. This method minimizes the exposure of the anti-theft device to any magnetic field generated by a permanent magnet inside the motor or any electromagnetic field generated by a wound field motor.

The present invention also contemplates a method for reactivating an anti-theft device installed in an article after the effectiveness of the anti-theft device has been decreased or completely destroyed by exposure to a magnetic field. This exposure may be a result of a magnetic field generated by a permanent magnet inside a motor or an electromagnetic field generated by a wound field motor. The method of the invention involves reactivating the anti-theft device by passing the article containing the anti-theft device through a magnetic field with the anti-theft device in the appropriate polarity to counteract any deactivation or decrease in effectiveness of the anti-theft device. This process makes the device operable again.

In one embodiment of the present invention the method includes using a receiver to verify that the anti-theft device is operating properly. The receiver may transmit a sound or other signal. The receiver may be mounted on a pedestal or post and placed at the end of an assembly line. Desirably, the receiver has a frequency of about 45 to about 70 kHz. More desirably, the receiver has a frequency of about 58 to about 60 kHz.

In another embodiment, the method of the present invention includes a final step of packaging the article for distribution. After the anti-theft device has been reactivated, and, if desired, the operability of the anti-theft device verified by a receiver, the article may then be placed in an appropriate container and distributed to consumers, distributors, and/or retailers. Upon the purchase of the article containing the anti-theft device, an authorized individual may deactivate the anti-theft device.

Deactivation devices typically use coils that are energized to generate a magnetic field of sufficient magnitude to render the anti-theft device inactive. The deactivated devices are no longer responsive to the incident energy of the electronic article surveillance system, and therefore, an alarm is not triggered. Examples of deactivation devices are set forth in U.S. Pat. No. 6,084,514.

Referring now to FIG. 10, a schematic block diagram of one embodiment of the method of the present invention is depicted. In this embodiment, an anti-theft device is placed within an article such as a power tool as the article is being manufactured 110. The anti-theft device is then exposed to a magnetic or electromagnetic field generated by operation of the motor in the article during quality assurance testing or other procedure 120. This exposure to the magnetic or electromagnetic field either entirely deactivates or reduces the effectiveness of the anti-theft device. To reactivate the anti-theft device, the article containing the anti-theft device is passed through a magnetic field with the anti-theft device in the appropriate polarity 130. This reactivation step produces an article that contains an effective and operational anti-theft device. To verify the effectiveness of the anti-theft device, the article is passed through a receiver 140. Once the effectiveness of the anti-theft device is verified, the article containing the anti-theft device is then packaged for distribution 150. When the article is sold to a consumer, the anti-theft device is deactivated to prevent triggering the detection equipment 160.

Of course, it should be understood that a wide range of changes and modifications could be made to the embodiments described above. It is therefore intended that the foregoing detailed description be regarded as illustrative rather than limiting, and that it be understood that it is the following claims, including all equivalents, that are intended to define the spirit and scope of this invention.

1. An article comprising a housing, a motor, and an anti-theft device disposed entirely within the housing.

2. The article of claim 1 wherein the anti-theft device responds to a magnetic field.

3. The article of claim 2 wherein the article comprises a power tool.

4. The article of claim 3 wherein the anti-theft device is placed entirely within a cavity formed in the housing and a covering is placed over the cavity.

5. The article of claim 4 wherein the cavity is located at a distance remote from the motor.

6. The article of claim 5 wherein the housing comprises a handle.

7. The article of claim 4 wherein the covering comprises an adhesive label.

8. A cord strap comprising a strap and an anti-theft device attached to or contained within the strap.

9. The cord strap of claim 8 wherein the anti-theft device responds to a magnetic field.

10. The cord strap of claim 9 further comprising means for attaching a first end of the strap to a cord.

11. The cord strap of claim 10 wherein the means for attaching a first end of the strap to a cord is a clip.

12. The cord strap of claim 11 wherein the strap is moveably engaged with the clip to create an adjustable loop.

13. The cord strap of claim 9 further comprising means for securing the strap around a cord.

14. The cord strap of claim 9 wherein the cord strap is attached to a cord on a power tool.

15. A method for deterring the theft of articles, comprising placing an anti-theft device inside an article that contains a motor and activating the anti-theft device by passing the article through a magnetic field with the device having an appropriate polarity.

16. The method of claim 15 wherein the article comprises a power tool.

17. The method of claim 16 wherein the power tool is placed in a package with the anti-theft device positioned to maximize the distance between the anti-theft device and the motor.
